(19) United States
(12) Patent Application Publication
(10) Pub. No.: US 2009/0017167 A1
(43) Pub. Date: Jan. 15, 2009

(54) MIXTURE AND BEVERAGE MADE THEREFROM FOR PROTECTING CELLULAR HYDRATION

(75) Inventors: Kim Krumhar, Carlsbad, CA (US); May Lam, Torrance, CA (US)

Correspondence Address: KNOBBE MARTENS OLSON & BEAR LLP, 2040 MAIN STREET, FOURTEENTH FLOOR, IRVINE, CA, 92614, US

(73) Assignee: Herbalife International Inc., Los Angeles, CA (US)

(21) Appl. No.: 12/170,751

(22) Filed: Jul. 10, 2008

Related U.S. Application Data
(60) Provisional application No. 60/949,210, filed on Jul. 11, 2007.

(51) Int. Cl. A23L 2/52; A23L 2/00

(52) U.S. Cl. 426/72; 426/74; 426/590; 426/548

(57) ABSTRACT

A beverage or tablet or mixture for preparing a beverage, the beverage with rehydration characteristics having an osmolality between approximately 150 to approximately 350 mOsm/liter. Embodiments of the beverage include a weight:weight ratio of sodium and potassium. Embodiments of the beverage include one or more rapidly releasing sugar and one or more delayed releasing sugar. Some embodiments include trehalose, citric acid, tocopherols, sodium chloride, calcium lactate pentahydrate, sodium citrate, potassium chloride, potassium citrate, ascorbic acid, magnesium oxide, sucralose, beta carotene and/or folic acid.

### CROSS-REFERENCE TO RELATED APPLICATIONS

This is a non-provisional application, which claims the benefit of U.S. Provisional Application Ser. No. 60/949,210, filed Jul. 11, 2007, the disclosure of which is hereby incorporated by reference in its entirety.

### BACKGROUND OF THE INVENTION

1. Field of the Invention

This invention relates to pharmaceuticals and herbal supplements. More particularly, the present invention relates to combinations of herbal and other chemical ingredients useful in protecting cellular hydration before, during and/or after physical exercise.

2. Description of the Related Art

Dehydration has been linked to a wide variety of animal physiological reactions, including dyspeptic pain, rheumatoid joint pain, anginal pain, hypertension, asthma, allergy, raised cholesterol, migraine headaches, chronic fatigue syndrome, elderly diabetes and others. Accordingly, a need to assure adequate water and extracellular electrolytes are available to provide adequate oxygen enrichment, pH adjustment and hydration in humans and other animals to protect cellular hydration is manifest.

### SUMMARY OF THE INVENTION

In one embodiment of a mixture for preparation of a beverage the beverage has a weight:weight ratio of sodium to potassium from approximately 0.6:1 to approximately 1.3:1 and an osmolality between 150-350 mOsm/liter.

In some embodiments the weight:weight ratio of sodium to potassium is from approximately 0.8:1 to approximately 1.1:1. In some embodiments the weight:weight ratio of sodium to potassium is from approximately 0.8:1 to approximately 0.9:1. In some embodiments the weight:weight ratio of sodium to potassium is from approximately 0.95:1 to approximately 1.05:1. In some embodiments the weight:weight ratio of sodium to potassium is approximately 0.85:1. In some embodiments the weight:weight ratio of sodium to potassium is approximately 1:1.

In some embodiments the osmolality of the beverage is between approximately 150 to approximately 350 mOsm/liter. In some embodiments the osmolality of the beverage is between approximately 180 to approximately 330 mOsm/liter. In some embodiments the osmolality of the beverage is between approximately 200 to approximately 320 mOsm/liter. In some embodiments the osmolality of the beverage is between approximately 220 to approximately 300 mOsm/liter. In some embodiments the osmolality of the beverage is between approximately 240 to approximately 290 mOsm/liter. In some embodiments the osmolality of the beverage is between approximately 250 to approximately 280 mOsm/liter. In some embodiments the osmolality of the beverage is between approximately 200 to approximately 260 mOsm/liter. In some embodiments the osmolality of the beverage is between approximately 210 to approximately 250 mOsm/liter. In some embodiments the osmolality of the beverage is between approximately 220 to approximately 240 mOsm/liter. In some embodiments the osmolality of the beverage is approximately 230 mOsm/liter.

In some embodiments the mixture comprises trehalose and sucralose. In some embodiments a weight:weight ratio of trehalose to sucralose is between approximately 40:1 and approximately 210:1. In some embodiments the weight:weight ratio of trehalose to sucralose is between approximately 200:1 and approximately 205:1. In some embodiments the mixture comprises sugar. In some embodiments the sugar comprises sucrose. In some embodiments a weight:weight ratio of trehalose to sucrose is between approximately 0.7:1.0 and approximately 1.3:1.0.

In some embodiments the mixture comprises tocopherols and vitamin C. In some embodiments the tocopherols and the vitamin C are present in amounts sufficient to protect cells from anti-oxidants released during metabolic activity. In some embodiments the tocopherols comprise gamma-tocopherols. In some embodiments the tocopherols comprise predominantly gamma-tocopherols. In some embodiments the tocopherols comprise greater than 50% of total tocopherols by weight gamma-tocopherols. In some embodiments the gamma-tocopherols comprise greater than 85% of total tocopherols by weight. In some embodiments the tocopherol is present in an amount sufficient to produce anti-inflammatory benefits in humans.

In some embodiments the beverage or drink mixture is configured to protect cellular hydration.

In some embodiments the mixture comprises trehalose dihydrate, sucralose, tocopherol, citric acid, beta carotene, ascorbic acid, calcium lactate pentahydrate, potassium chloride, potassium citrate, magnesium oxide, sodium citrate and sodium chloride. In some embodiments the mixture comprises comprising 20-60% by weight trehalose dihydrate, 0.01-2% by weight sucralose, 1-10% by weight tocopherol, 4-20% by weight citric acid, 0.01-2% by weight beta carotene, 0.1-5% by weight ascorbic acid, 0.1-5% by weight calcium lactate pentahydrate, 0.1-5% by weight potassium chloride, 0.1-5% by weight potassium citrate, 0.1-2% by weight magnesium oxide, 0.1-5% by weight sodium citrate and 0.1-5% by weight sodium chloride.

In one embodiment a method for controlling release of carbohydrates during exercise comprises identifying an individual performing exercise and providing the individual an effective amount a drink mixture comprising trehalose and sucrose. In some embodiments the exercise comprises flexibility exercises, aerobic exercises or anaerobic exercises.

### DETAILED DESCRIPTION OF THE PREFERRED EMBODIMENT

Various embodiments provide a beverage or drink mixture having an osmolality between approximately 150 to approximately 350 mOsm/liter. In some embodiments the beverage or drink mixture has a weight:weight ratio of sodium to potassium from approximately 0.6:1 to approximately 1.3:1. The beverage or drink mixture provides rapid rehydration to individuals who perform physical activity, such as flexibility exercises, aerobic exercise and/or anaerobic exercises. In some embodiments the beverage or drink mixture comprises active ingredients including one or more rapid releasing sugars and one or more delayed releasing sugars. In some embodiments the beverage or drink mixture comprises active ingredients including tocopherols and vitamin C. In some embodiments active ingredients include trehalose dihydrate, sucralose, tocopherol, citric acid, beta carotene, ascorbic acid, calcium lactate pentahydrate, potassium chloride, potassium citrate, magnesium oxide, sodium citrate, sodium chloride, granulated sugars, fructose, glucose, sucrose or folic acid. In some embodiments, the beverage or drink mixture comprises flavor. While not being bound by any particular theory, it is believed that these compositions have a low potential for inducing glycemia and a high fat+water soluble antioxidant load.

Rapidly releasing sugars may include basic monosaccharides immediately available (without further processing) for absorption by the body on a cellular level. For example, monosaccharides that are rapidly releasing sugars include, but are not limited to, glucose, fructose, galactose, and ribose. In some embodiments rapidly releasing sugars comprise 10%-80% (e.g., equal to, greater than, at least, or any number in between 10%, 15%, 20%, 25%, 30%, 35%, 40%, 45%, 50%, 55%, 60%, 65%, 70%, 75% or 80%) by weight of the beverage or drink mix.

Delayed releasing sugars may include disaccharides (including lactose, sucrose, trehalose, maltose, and/or cellobiose), oligosaccharides or polysaccharides, which must be broken down into simple sugars before being absorbed and used for energy by the body on a cellular level. In some embodiments the delayed releasing sugar may be a sugar alcohol (e.g. erythritol, isomalt, lactitol, maltitol, mannitol, sorbitol, xylitol, etc.). In some embodiments delayed releasing sugars comprise 0.01%-60% (e.g., equal to, greater than, at least, or any number in between 0.01%, 0.05%, 0.1%, 0.5%, 1%, 5%, 10%, 15%, 20%, 25%, 30%, 35%, 40%, 45%, 50%, 55% or 60%) by weight of the beverage or drink mix.

In some embodiments the tocopherol comprises a mixture of natural tocopherol isomers rich in gamma tocopherol, which may be an effective anti-inflammatory agents and COX-2 inhibitors. In some embodiments the tocopherol comprises a gamma-tocopherol. In some embodiments the tocopherol may be a COX-2 inhibitor. In some embodiments the tocopherol comprises 0.1%-15% (e.g., equal to, greater than, at least, or any number in between 0.1%, 0.5%, 1%, 2%, 3%, 4%, 5%, 6%, 7%, 8%, 9%, 10%, 11%, 12%, 13%, 14% or 15%) by weight of the beverage or drink mix. In some embodiments, tocopherols may aid in modulating the absorption of sugars. Tocopherols will be discussed in greater detail below.

Herein, the term “approximately” includes values ±10%. In preferred embodiments the term “approximately” includes values ±5%. In more preferred embodiments the term “approximately” includes values ±2%.

### Granulated Sugars

Granulated sugars refer to one or more forms of monosaccharide, disaccharide, oligosaccharide or polysaccharide in a crystal form. In some embodiments a monosaccharide includes glucose. In some embodiments a monosaccharide includes fructose. In some embodiments a disaccharide includes sucrose. Sucrose comprises a glucose molecule and a fructose molecule.

Granulated sugar comes in various crystal sizes: (1) coarse-grained sugars, (2) normal granulated sugars for table use, (3) finer grades result from selectively sieving the granulated sugar which includes caster (or castor) and superfine sugar, also called baker's sugar, berry sugar, or bar sugar, and (4) Finest grades. In some embodiments, the beverage or drink mixture includes the baker's sugar.

Glucose, including dextrose (D-glucose), is the only biologically active isomer of aldohexose glucose sugars. Glucose is the most important carbohydrate in biology because cells use it both as a source of energy and as a metabolic intermediate. Glucose is used by either aerobic or anaerobic respiration. Through aerobic respiration, glucose provides approximately 4 kilocalories (17 kilojoules) of food energy per gram. Through glycolysis and the citric acid cycle, glucose is oxidized to eventually form CO₂ and water, yielding energy, mostly in the form of ATP. In addition to exercise, insulin reactions and other metabolic mechanisms regulate the concentration of glucose in the blood.

All major dietary carbohydrates contain glucose, either alone as in starch and glycogen, or together with another monosaccharide, as in sucrose and lactose. Some glucose goes directly to fuel brain cells and erythrocytes. Some glucose is stored as glycogen, while some glucose is used to power reactions which synthesize certain fats.

Fructose (or levulose) is also a monosaccharide found in many foods and is one of the three most important blood sugars along with glucose and galactose. While most carbohydrates have approximately the same amount of calories, manufacturers can use less of fructose to get the same result since fructose is the sweetest naturally occurring sugar, estimated to be twice as sweet as sucrose. The free fructose present in fruits, their juice, and honey is responsible for the greater sweetness of these natural sugar sources.

Fructose is used as a substitute for sucrose (common sugar) because it is less expensive and has little effect on measured blood glucose levels. Fructose is also often recommended for, and consumed by, people with diabetes mellitus or hypoglycemia, because its Glycemic Index (GI) is significantly lower than glucose, sucrose and starches. The low GI is due to the unique and lengthy metabolic pathway of fructose, which involves phosphorylation and a multi-step enzymatic process in the liver. Although every cell in the body can metabolize glucose, most fructose must be metabolized in the liver.

### Insulin

Insulin is an anabolic polypeptide hormone produced by the pancreas that regulates carbohydrate metabolism. Apart from being the primary agent in carbohydrate homeostasis, insulin has effects on fat metabolism and it changes the liver's activity in storing or releasing glucose and in processing blood lipids, and in other tissues such as fat and muscle. The amount of insulin in circulation has widespread effects throughout the body. Among other things, the actions of insulin on the global human metabolism level include: control of cellular intake of certain substances, most prominently glucose in muscle and adipose tissue; increase of DNA replication and protein synthesis via control of amino acid uptake; and modification of the activity of numerous enzymes (allosteric effect). Additionally, insulin helps increase of glycogen synthesis, increase fatty acid synthesis, increase esterification of fatty acids, decrease proteinolysis, decrease lipolysis, decrease gluconeogenesis, increase amino acid uptake, increase potassium uptake, and increase arterial muscle tone.

The effects of insulin on glucose metabolism vary depending on the target tissue. For example, insulin facilitates entry of glucose into muscle, adipose and several other tissues. Additionally, insulin stimulates the liver to store glucose in the form of glycogen. Thus, insulin regulates the blood sugar levels in the body. It does not let the body drop its blood sugar levels too high or too low. When glucose is liberated from dietary carbohydrate, such as starch or sucrose, by hydrolysis within the small intestine, glucose is then absorbed into the blood, which stimulates release of insulin. Insulin acts on cells throughout the body to stimulate uptake, utilization and storage of glucose. If insulin levels “spike” too quickly or for too long a period of time, corresponding blood glucose levels may drop too quickly. Without adequate glucose in the blood, both metabolism and athletic performance during and after exercise may be adversely affected. Thus, an insulin spike can have adverse effects on metabolism and/or athletic performance.

An insulin spike may be measured in terms of a comparison between a first insulin level corresponding to the introduction of an amount of monosaccharide, trehalose or sucrose introduced into a mammal and a second insulin level corresponding to the introduction of approximately the same amount of a mixture of trehalose and sucrose as discussed herein. In some embodiments a “spike” corresponds to a 50% increase from a baseline plasma insulin level. In some embodiments a spike corresponds to a 75% increase from a baseline plasma insulin level. In some embodiments a spike corresponds to a 100% increase from a baseline plasma insulin level. In some embodiments a spike corresponds to a 200% increase from a baseline plasma insulin level. In some embodiments, a spike corresponds to a 500% increase from a baseline plasma insulin level. In some embodiments a spike corresponds to an increase from approximately 20 mU/L to approximately 95 mU/L.

It may be demonstrated that in instances where an amount of the mixture of trehalose and sucrose is introduced into a mammal, the introduction of the mixture creates a first spike or a “jump” in insulin levels. The first spike or jump in insulin levels corresponds to a height of a curve when insulin levels are plotted on a curve. In some embodiments the first spike or jump may be less than 80% of a second spike or jump in insulin levels corresponding to approximately the same amount of a monosaccharide introduced in a mammal under similar conditions. In some embodiments the first spike or jump may be less than 80% of a second spike or jump in insulin levels corresponding to approximately the same amount of a trehalose introduced in a mammal under similar conditions. In some embodiments the first spike or jump may be less than 80% of a second spike or jump in insulin levels corresponding to approximately the same amount of sucrose introduced in a mammal under similar conditions. In some embodiments the first spike or jump may be less than 50% of a second spike or jump in insulin levels corresponding to approximately the same amount of a monosaccharide introduced in a mammal under similar conditions. In some embodiments the first spike or jump may be less than 50% of a second spike or jump in insulin levels corresponding to approximately the same amount of a trehalose introduced in a mammal under similar conditions. In some embodiments the first spike or jump may be less than 50% of a second spike or jump in insulin levels corresponding to approximately the same amount of sucrose introduced in a mammal under similar conditions. In some embodiments the first spike or jump may be less than 30% of a second spike or jump in insulin levels corresponding to approximately the same amount of a monosaccharide introduced in a mammal under similar conditions. In some embodiments the first spike or jump may be less than 30% of a second spike or jump in insulin levels corresponding to approximately the same amount of a trehalose introduced in a mammal under similar conditions. In some embodiments the first spike or jump may be less than 30% of a second spike or jump in insulin levels corresponding to approximately the same amount of sucrose introduced in a mammal under similar conditions.

In some embodiments, the modulation of insulin response as a function of trehalose in a mixture of trehalose and sucrose content is linear. In some embodiments, the modulation of insulin response as a function of trehalose in a mixture of trehalose and sucrose content is second order.

### Trehalose

Trehalose, also known as mycose, is an alpha-linked (disaccharide) sugar found extensively in nature. It is implicated in anhydrobiosis—the ability of plants and animals to withstand prolonged periods of desiccation. The sugar is thought to form a gel phase as cells dehydrate, which prevents disruption of internal cell organelles by effectively splinting them in position. Rehydration then allows normal cellular activity to be resumed without the major, generally lethal damage, which would normally follow a dehydration/rehydration cycle. Trehalose has the added advantage of being an antioxidant.

Trehalose is less soluble and less sweet than sucrose, thus it is seldom used as a direct replacement for conventional sweeteners, such as sucrose. Trehalose releases two molecules of glucose, which can then be readily absorbed by the body. Because trehalose is slowly metabolized to form glucose, a beverage or drink mixture containing trehalose can provide a sustained source of blood glucose over an extended timeframe compared to other drinks sweetened with glycemic carbohydrates like glucose and short chain maltodextrins.

### Citric Acid

Citric acid is a weak organic acid found in citrus fruits. It is a natural preservative and in some embodiments is used to add an acidic (sour) taste. It is also important both as an intermediate in the citric acid cycle and as an antioxidant.

Citric acid is one of a series of compounds involved in the physiological oxidation of fats, proteins, and carbohydrates to carbon dioxide and water. This series of chemical reactions is central to nearly all metabolic reactions, and is the source of two-thirds of the food-derived energy in higher organisms. The series of reactions is properly known as the tricarboxylic acid cycle, but it is also known as the citric acid cycle or the Krebs cycle.

In some embodiments citric acid is used as a flavoring and preservative. Citrate salts of various metals are used to deliver those minerals in a biologically available form in many dietary supplements. Additionally, the buffering properties of citrates may be used to control pH in a tablet, beverage or drink mix.

### Tocopherols

Tocopherol, or vitamin E, is a fat-soluble vitamin used as an antioxidant. Natural vitamin E exists in eight different forms or isomers, four tocopherols and four tocotrienols. All isomers can easily penetrate into biological membranes.

Alpha-tocopherol is traditionally recognized as the most active form of vitamin E in humans, and is a powerful biological antioxidant. 1 IU of vitamin E is defined as the biological equivalent of 0.667 milligrams of RRR-alpha-tocopherol (formerly named d-alpha-tocopherol, or of 1 milligram of all-rac-alpha-tocopheryl acetate (commercially called dl-alpha-tocopheryl acetate, the original d, 1-synthetic molecular mix, properly named 2-ambo-alpha-tocopherol, is no longer manufactured). Commercially available blends of natural vitamin E include “mixed tocopherols” and “high gamma tocopherol” formulas.

Similar to alpha-tocopherol, gamma-tocopherol is also a potent antioxidant that can scavenge reactive nitrogen species (RNS), which, like reactive oxygen species, can damage proteins, lipids, and DNA. But gamma-tocopherol is more effective than alpha-tocopherol is in scavenging RNS and in inhibiting the oxidation of phopholipids by the RNS peroxynitrite that may cause significant cellular damage by reacting with DNA, proteins and/or phospholipids. The chemical difference between alpha-tocopherol and gamma-tocopherol is the presence in alpha-tocopherol of a methyl group in the 5-position of the chromanol ring.

Gamma-tocopherol also has anti-atherogenic, anti-apoptotic, antithrombotic, anticoagulant, anticarcinogenic and immunomodulatory activities. Gamma-tocopherol, but not alpha-tocopherol, inhibits cyclooxygenase activity and, thus, possesses anti-inflammatory properties. Some human and animal studies indicate that plasma concentrations of gamma-tocopherol are inversely associated with the incidence of cardiovascular disease and prostate cancer.

In some embodiments antioxidants such as vitamin E act to protect cells against the damaging effects of free radicals, which are potentially damaging by-products of the body's metabolism. Free radicals can cause cell damage that may contribute to the development of cardiovascular disease and cancer. Vitamin C and other anti-oxidants recycle vitamin E end-products back into effective suppressors of free radicals.

Vitamin E also blocks the formation of nitrosamines, which are carcinogens formed in the stomach from nitrites consumed in the diet. In some embodiments Vitamin E enhances immune function and thus protects against the development of cancer.

The U.S. Dietary Reference Intake (DRI) Recommended Daily Amount (RDA) for a 25-year old male for vitamin E is 15 mg/day. This is approximately 22.5 IU/day. The DR1 for vitamin E is based on the alpha-tocopherol form because it is the most active form as originally tested. Vegetable oils are such a good dietary source of vitamin E. Vitamin E supplements are absorbed best when taken with meals. But low-fat diets can substantially decrease vitamin E intakes if food choices are not carefully made to enhance alpha-tocopherol intakes. In some embodiments vitamin E acts as an anticoagulant and thus may increase risk of bleeding problems.

Vitamin E deficiency is most likely to occur in persons who cannot absorb dietary fat and in individuals with rare disorders of fat metabolism because dietary fat is needed for the absorption of vitamin E from the gastrointestinal tract. Individuals with a vitamin E deficiency or abetalipoproteinemia may ingest vitamin E supplements to treat neurological problems due to poor transmission of nerve impulses, muscle weakness, and degeneration of the retina. In addition, individuals with cystic fibrosis, individuals who have had part or all of their stomach removed and individuals with malabsorptive problems, such as Crohn's disease, liver disease or pancreatic insufficiency, may not absorb fat, and thus may also require vitamin E supplements.

In some embodiments, vitamin E may help prevent or delay coronary heart disease by limiting the oxidation of LDL-cholesterol. Also, vitamin E also may help prevent the formation of blood clots, which could lead to a heart attack. Additionally, studies known in the art have associated higher vitamin E intake with lower rates of heart disease and decreased mortality from heart disease. In some embodiments, regular dosage of vitamin E may prevent or delay cataract growth, delay onset and progression of Age-Related Macular Degeneration, and/or protect against Parkinson's disease.

### Sodium Chloride

Sodium chloride, also known as common salt, table salt, or halite, is a chemical compound with the formula NaCl. As the main ingredient in edible salt, it is commonly used as a condiment, flavor enhancer and food preservative. Salt flavor is one of the basic tastes.

Sodium chloride is essential to life on Earth. Most biological tissues and body fluids contain a varying amount of salt. Sodium (Na⁺) and chloride (Cl⁻) are the principal ions in the extracellular fluid of many multicellular organisms, which includes blood plasma. As such, they play critical roles in a number of life-sustaining processes, including maintenance of membrane potential, regulation of the water content (fluid balance) of the body, nutrient absorption and transport, and maintenance of blood volume and blood pressure.

In neurons, Na⁺ is required for sodium channels to function, allowing transmission of synaptic messages. The absence of Na⁺ results in loss of function and loss of control over muscle contractions. Similarly, epithelial tissues require Cl⁻ to function properly.

### Calcium Lactate Pentahydrate

Calcium lactate is a white crystalline salt made by the action of lactic acid on calcium carbonate. It is used in foods (as a baking powder) and given medicinally. In some embodiments calcium lactate is used as an antacid and/or to treat calcium deficiencies. Calcium lactate can be absorbed at various pHs. In some embodiments calcium lactate increases the remineralization of tooth enamel and thus prevents tooth decay. In some embodiments, calcium lactate is a blood coagulant.

### Sodium Citrate

Sodium citrate is the sodium salt of citric acid. It possesses a saline, mildly tart, flavor (sour salt). In some embodiments sodium citrate is flavor or as a preservative. In some embodiments sodium citrate is a flavoring agent. As a conjugate base of a weak acid, citrate is as a buffering agent, which resists changes in pH. In some embodiments sodium citrate is used to control acidity in some substances. In some embodiments sodium citrate improves running or exercise performance. In some embodiments sodium citrate is used to relieve discomfort in urinary tract infections such as cystitis, and/or as an osmotic laxative.

### Potassium Chloride

Potassium chloride (KCl), commonly known as “Muriate of Potash,” is a source of chloride ion. In some embodiments it can be used as a salt substitute for sodium chloride. In other embodiments it is used in combination with sodium chloride.

Potassium is a mineral vital for many normal functions of the human body including regular heartbeat. In some embodiments potassium chloride is used to supplement natural potassium in the body. Additionally, in some embodiments, potassium chloride is used to treat hypokalemia and associated conditions and digitalis poisoning and as an electrolyte replenisher.

### Potassium Citrate

In some embodiments potassium citrate is used to control uric acid and thus prevent the formation of kidney stones caused by high levels of calcium or uric acid in the urine.

Potassium citrate is rapidly absorbed and excreted in the urine as the carbonate. Thus, in some embodiments, potassium citrate is effective in reducing pain and frequency of micturition caused by highly acid urine. In some embodiments it is used as a non-irritating diuretic. In some embodiments it may be used to reduce the danger of crystalluria during sulfonamide therapy.

### Ascorbic Acid

Ascorbic acid is an organic acid with antioxidant properties. Because ascorbic acid and its sodium, potassium, and calcium salts are water soluble they cannot protect fats from oxidation. Thus, in some embodiments, ascorbate acts as an antioxidant by making itself available for energetically favorable oxidation. Many oxidants (typically, reactive oxygen species), such as the hydroxyl radical (formed from hydrogen peroxide), contain an unpaired electron, and thus are highly reactive and damaging to humans and plants at the molecular level. This is due to their interaction with nucleic acid, proteins and lipids. Reactive oxygen species oxidize ascorbate first to monodehydroascorbate and then dehydroascorbate. Reactive oxygen species are reduced to water while the oxidized forms of ascorbate both are relatively stable and do not cause cellular damage.

The L-enantiomer of ascorbic acid, vitamin C, is an essential nutrient for a range of essential metabolic reactions in all animals and plants. As mentioned above, vitamin C is a highly effective antioxidant, acting to protect the body against oxidative stress. In some embodiments vitamin C is a substrate for ascorbate peroxidase, as well as an enzyme cofactor for the biosynthesis of many vital biochemicals. In some embodiments vitamin C acts as an electron donor for eight different enzymes that are involved in important biological processes such as collagen hydroxylation, carnitine biosynthesis, biosynthesis of norepinephrine from dopamine, and modulation of tyrosine metabolism.

### Magnesium Oxide

Magnesium oxide, or magnesia, is a white solid mineral that occurs naturally as periclase. In some embodiments it is used as an antacid to relieve heartburn, sour stomach, or acid indigestion. In some embodiments it is used as a short-term laxative to rapidly empty the bowel. In some embodiments it is used as a dietary magnesium supplement. MgO is hygroscopic in nature and care must be taken to protect it from moisture. Magnesium hydroxide (Mg(OH)₂) which forms in the presence of water can be reversed by heating to separate moisture.

### Sucralose

Sucralose is an artificial sweetener also known by the trade name Splenda®. It is 320-1,000 times as sweet as sucrose, making it roughly twice as sweet as saccharin and four times as sweet as aspartame. It is manufactured by the selective chlorination of sucrose, by which three of sucrose's hydroxyl groups are substituted with chlorine atoms to produce 1,6-dichloro-1,6-dideoxy-β-D-fructo-furanosyl 4-chloro-4-deoxy-α-D-galactopyranoside or C₁₂H₁₉C₁₃O₈. Unlike aspartame, it is stable under heat and over a broad range of pH conditions, and can be used in baking, or in products that require a longer shelf life.

Sucralose is a chlorocarbon, thus very little of it is absorbed and metabolized by the body's digestive tract. Although many chlorocarbons are toxic, sucralose is extremely insoluble in fat and does not accumulate in fat like most chlorinated hydrocarbons. In addition, sucralose does not break down or dechlorinate. The bulk of sucralose ingested does not leave the gastrointestinal tract and is directly excreted in the feces while up to 27% of it is absorbed. The amount that is absorbed from the GI tract is largely removed from the blood stream by the kidneys and excreted in the urine with 20-30% of the absorbed sucralose being metabolized.

In some embodiments sucralose mixed with maltodextrin and dextrose can be used as a bulking agent.

In some embodiments sucralose is used as a replacement of, or in combination with other artificial sweeteners such as aspartame, acesulfame potassium or high-fructose corn syrup. Sucralose is the most heat stable artificial sweetener available, allowing it to be used in many recipes without any use of sugar.

### Beta Carotene

Carotenes are carotenoids containing no oxygen. Carotene is a terpene, synthesized biochemically from eight isoprene units. It comes in two primary forms: alpha-carotene (α-carotene) and beta-carotene (β-carotene). Gamma, delta and epsilon (γ, δ and ε) carotene also exist. α-carotene and β-carotene differ in the position of double bonds in the cyclic group at the end. The two ends of the β-carotene molecule are structurally identical, and each end group of nine carbon atoms form a β-ring. β-carotene is composed of two retinyl groups, and is broken down in the mucosa of the small intestine by beta-carotene dioxygenase to retinol, a form of vitamin A. Carotene can be stored in the liver and converted to vitamin A as needed.

Beta-carotene is a precursor to vitamin A in the body. Vitamin A is essential for normal growth, regulation of metabolism, vision, cell structure, strong bones and teeth, healthy skin, and protecting the linings of digestive, respiratory and urinary tracts from infection. The symptoms of vitamin A deficiency include vision problems (inability to see at night), bone or teeth development problems, unexplained irritability, skin rashes, hair loss, dry or inflamed eyes, loss of appetite, and recurring infections.

β-carotene is also an anti-oxidant useful for curbing the excess of free radicals in the body. Free radicals are unstable by-products of cells “burning” oxygen for energy that can damage the basic structure of cells and thus lead to chronic diseases (notably cancer and heart disease) and accelerate the aging process. In some embodiments β-carotene is used as a dietary supplement in preventing cancer, heart disease, and a number of other diseases, including cystic fibrosis and arthritis. β-carotene also boosts immunity and supports good vision. β-carotene is fat-soluble.

### Folic Acid

Folic acid and folate are forms of the water-soluble vitamin B9. Leaf vegetables such as spinach and turnip greens, dried beans and peas, fortified cereal products, sunflower seeds and certain other fruits and vegetables are rich sources of folate, as is liver. Many adults do not consume adequate folate. Increased folic acid content of commonly eaten foods, such as some breakfast cereals (ready-to-eat and other) and grains which are fortified with 25% to 100% of the recommended dietary allowance (RDA) for folic acid, helps to provide recommended amounts of folate equivalents.

Folate is necessary for the production and maintenance of new cells, which is especially important during periods of rapid cell division and growth such as infancy and pregnancy. Folate is involved in the replication, repair, and functioning of DNA and it also helps prevent changes or damages to DNA that may lead to cancer. Folate deficiency hinders DNA synthesis and cell division, affecting most clinically the bone marrow, a site of rapid cell turnover. Because RNA and protein synthesis are not hindered, large red blood cells called megaloblasts are produced, resulting in megaloblastic anemia. Both adults and children need folate to make normal red blood cells and prevent anemia. Several studies have associated diets low in folate with increased risk of breast, pancreatic, and colon cancer. Low concentrations of folate also may increase the level of homocysteine in the human body, which is an independent risk factor for heart disease and stroke.

Folic acid is very important for all women who may become pregnant. Adequate folate intake during the periconceptional period, the time just before and just after a woman becomes pregnant, helps protect against a number of congenital malformations including neural tube defects, which may result in malformations of the spine (spina bifida), skull and brain (anencephaly). The risk of neural tube defects is significantly reduced when supplemental folic acid is consumed in addition to a healthy diet prior to and during the first month following conception. Women who could become pregnant are advised to eat foods fortified with folic acid or take supplements in addition to eating folate-rich foods to reduce the risk of some serious birth defects. Taking 400 micrograms of synthetic folic acid daily from fortified foods and/or supplements has been suggested. The Recommended Dietary Allowance (RDA) for folate equivalents for pregnant women is 600 micrograms.

Folate intake counteracts breast cancer risk associated with alcohol consumption and women who drink alcohol and have a high folate intake are not at increased risk of cancer. Those who have a high (200 micrograms or more per day) level of folate (folic acid or Vitamin B9) in their diet are not at increased risk of breast cancer compared to those who abstain from alcohol.

Folate is important for cells and tissues that rapidly divide. Cancer cells divide rapidly, and drugs that interfere with folate metabolism are used to treat cancer. Methotrexate is a drug often used to treat cancer because it inhibits the production of the active form, tetrahydrofolate. Unfortunately, methotrexate can be toxic, producing side effects such as inflammation in the digestive tract that make it difficult to eat normally.

In some embodiments, use of folic acid in addition to antidepressant medication is beneficial to treat depression. In some embodiments a daily dose of folic acid increases short term memory, mental agility and verbal fluency.

### Flavors

Flavors are additives that give food a particular taste or smell, and may be derived from naturally occurring ingredients or prepared synthetically. In some embodiments, the flavor may include chocolate, vanilla, cola, coffee, latte, cappuccino, butterscotch, almond, mint, peach, grape, pear, passion fruit, pineapple, banana or banana puree, apricot, citrus, orange, lemon, grapefruit, apple, cranberry, tomato, mango, papaya, lime, tangerine, cherry, blueberry, strawberry, raspberry, coconut, carrot and/or mixtures thereof.

### Osmolality

Osmolality is a measure of the osmoles of solute per kilogram of solvent. (Osmolarity is a measure of the total number of osmoles liter of solution.) An osmole defines the number of moles of chemical compound that contribute to a solution's osmotic pressure. In a drink, these chemical compounds include carbohydrates, electrolytes, sweeteners and preservatives. In blood plasma, the compounds similarly include electrolytes, proteins and carbohydrates. The primary ions of electrolytes in physiology are sodium (Na⁺), potassium (K⁺), calcium (Ca²⁺), magnesium (Mg²⁺), chloride (Cl⁻), phosphate (PO₄³⁻), and hydrogen carbonate (HCO₃⁻). In oral rehydration therapy, electrolyte drinks containing sodium and potassium salts are used to replenish the body's water and electrolyte levels after dehydration caused by exercise, diaphoresis, diarrhea, vomiting or starvation. Giving pure water to such a person is not the best way to restore fluid levels because it dilutes the salts inside the body's cells and interferes with their chemical functions, which can lead to water intoxication.

Osmolality increases with dehydration, but decreases with overhydration. In human body, the osmolality of plasma is closely regulated by anti-diuretic hormone (ADH). In response to even small increases in plasma osmolality (usually rises in plasma sodium), ADH release from the pituitary is increased causing water resorption in the distal tubules and collecting ducts of the kidney and correction of the increased osmolality. The opposite happens in response to a low plasma osmolality with decreased ADH secretion and water loss through the kidneys.

Blood has an osmolality of 280 to 330 mOsm/kg. Therefore, drinks with an osmolality of 270 to 330 mOsm/kg are said to be in balance with the body's fluid and are called iosotonic. Isotonic drinks can quickly replace fluids lost in human body by sweating and supplies a boost of carbohydrate, and thus is the choice for most people who practice physical activity, such as flexibility exercises, aerobic exercises and/or anaerobic exercises.

The speed at which fluid from a drink gets into the body is affected by the speed at which it is emptied from the stomach and the rate at which it is absorbed through the walls of the small intestine. Electrolytes, especially sodium and potassium, in a drink will reduce urine output, enable the fluid to empty quickly from the stomach, promote fluid absorption from the intestine and encourage fluid retention.

In some embodiments the osmolality of the beverage is between approximately 150 to approximately 350 mOsm/liter. In some embodiments the osmolality of the beverage is between approximately 180 to approximately 330 mOsm/liter. In some embodiments the osmolality of the beverage is between approximately 200 to approximately 320 mOsm/liter. In some embodiments the osmolality of the beverage is between approximately 220 to approximately 300 mOsm/liter. In some embodiments the osmolality of the beverage is between approximately 240 to approximately 290 mOsm/liter. In some embodiments the osmolality of the beverage is between approximately 250 to approximately 280 mOsm/liter. In some embodiments the osmolality of the beverage is between approximately 200 to approximately 260 mOsm/liter. In some embodiments the osmolality of the beverage is between approximately 210 to approximately 250 mOsm/liter. In some embodiments the osmolality of the beverage is between approximately 220 to approximately 240 mOsm/liter. In some embodiments the osmolality of the beverage is approximately 230 mOsm/liter.

In some embodiments, the beverage or drink mixture has a weight:weight ratio of sodium to potassium from approximately 0.6:1 to approximately 1.3:1. In some embodiments, the beverage or drink mixture has a weight:weight ratio of sodium to potassium from approximately 0.8:1 to approximately 1.1:1. In some embodiments, the beverage or drink has a weight:weight ratio of sodium to potassium from approximately 0.8:1 to approximately 0.9:1. In some embodiments, the beverage or drink has a weight:weight ratio of sodium to potassium approximately 0.85:1. In some embodiments, the beverage or drink has a weight:weight ratio of sodium to potassium from approximately 0.95:1 to approximately 1.05:1. In some embodiments, the beverage or drink has a weight:weight ratio of sodium to potassium approximately 1:1.

### Cellular Hydration

Over all cellular hydration is the primary indicator for how effectively any part of the body is hydrated. During performing physical activity, such as flexibility exercises, aerobic exercises and/or anaerobic exercises, sweat is lost from the body, which can produce a state of dehydration. Dehydration is associated with a reduction in plasma volume, an impairment of body heat dissipation and a decrease in endurance performance. Studies have shown that loss of water, redistribution and loss of electrolytes, and the depletion of endogenous carbohydrate stores are primary causes of fatigue. Therefore, to maintain the body's physical capabilities, it is essential to provide water, electrolytes, carbohydrate and other nutrients to the body timely and appropriately.

Additionally, recent research has determined that the volume of fluid within the cell plays important roles in regulating protein synthesis and a number of physiological processes in cellular metabolism. For example, cell swelling decreases protein breakdown while stimulates protein synthesis. On the other hand, a reduction in cell volume promotes protein breakdown and inhibits protein synthesis. Since cell volume influences the expression of several genes, the activity of various enzymes, the impact of hormones on the cell (e.g., insulin and glucagon) and helps to regulate cellular metabolism by modifying responsiveness to signaling molecules, it has been suggested that short-term changes in cellular hydration serve as a potent modifier of cellular metabolism and gene expression. Consequently, for people who perform physical activity, such as flexibility exercises, aerobic exercises and/or anaerobic exercises, maintaining cellular hydration is important in optimizing cellular function and protein synthesis. People who do not maintain cellular hydration during physical activity may inhibit protein synthesis, and thus gain lesser in muscle mass and/or require longer recovery between workouts. Also, since exercise can temporarily alter cellular hydration by causing a shifting of fluid and nutrients in and out of the cell, increasing oxidative stress and promoting a release of anabolic hormones, preventing dehydration and optimizing cell hydration following exercise may be important in increasing the anabolic response to resistance-training.

### Pharmaceutical Compositions

In some embodiments, the active ingredients and mixtures of active ingredients may be used, for example, in pharmaceutical compositions comprising a pharmaceutically acceptable carrier prepared for storage and subsequent administration. Also, some embodiments include use of the above-described active ingredients with a pharmaceutically acceptable carrier or diluent. Acceptable carriers or diluents for therapeutic use are well known in the pharmaceutical art, and are described, for example, in Remington's Pharmaceutical Sciences, 18th Ed., Mack Publishing Co., Easton, Pa. (1990), which is incorporated herein by reference in its entirety. Preservatives, stabilizers, dyes and even flavoring agents may be provided in the pharmaceutical composition. For example, sodium benzoate, ascorbic acid and esters of p-hydroxybenzoic acid may be added as preservatives. In addition, antioxidants and suspending agents may be used.

Compositions of the active ingredients may be formulated and used as tablets, capsules, or elixirs for oral administration; suppositories for rectal administration; sterile solutions, suspensions for injectable administration; patches for transdermal administration, and sub-dermal deposits and the like. Injectables can be prepared in conventional forms, either as liquid solutions or suspensions, solid forms suitable for solution or suspension in liquid prior to injection, or as emulsions. Suitable excipients are, for example, water, saline, dextrose, mannitol, lactose, lecithin, albumin, sodium glutamate, cysteine hydrochloride, and the like. In addition, if desired, the injectable pharmaceutical compositions may contain minor amounts of nontoxic auxiliary substances, such as wetting agents, pH buffering agents, and the like. If desired, absorption enhancing preparations (for example, liposomes), may be utilized.

For injection, the agents of the invention may be formulated in aqueous solutions, preferably in physiologically compatible buffers such as Hanks' solution, Ringer's solution, or physiological saline buffer. For such transmucosal administration, penetrants appropriate to the barrier to be permeated are used in the formulation. Such penetrants are generally known in the art. Use of pharmaceutically acceptable carriers to formulate the ingredients herein disclosed for the practice of the invention into dosages suitable for systemic administration is within the scope of the invention. With proper choice of carrier and suitable manufacturing practice, the compositions disclosed herein, in particular, those formulated as solutions, may be administered parenterally, such as by intravenous injection. The active ingredients can be formulated readily using pharmaceutically acceptable carriers well known in the art into dosages suitable for oral administration. Such carriers enable the compounds of the invention to be formulated as tablets, pills, capsules, liquids, gels, syrups, slurries, suspensions and the like, for oral ingestion by a patient to be treated.

Pharmaceutical formulations for parenteral administration include aqueous solutions of the active ingredients in water-soluble form. Additionally, suspensions of the active ingredients may be prepared as appropriate oily injection suspensions. Suitable lipophilic solvents or vehicles include fatty oils such as sesame oil, or other organic oils such as soybean, grapefruit or almond oils, or synthetic fatty acid esters, such as ethyl oleate or triglycerides, or liposomes. Aqueous injection suspensions may contain substances which increase the viscosity of the suspension, such as sodium carboxymethyl cellulose, sorbitol, or dextran. Optionally, the suspension may also contain suitable stabilizers or agents that increase the solubility of the ingredients to allow for the preparation of highly concentrated solutions.

Pharmaceutical preparations for oral use can be obtained by combining the active ingredients with solid excipient, optionally grinding a resulting mixture, and processing the mixture of granules, after adding suitable auxiliaries, if desired, to obtain tablets or dragee cores. Suitable excipients are, in particular, fillers such as sugars, including lactose, sucrose, mannitol, or sorbitol; cellulose preparations such as, for example, maize starch, wheat starch, rice starch, potato starch, gelatin, gum tragacanth, methyl cellulose, hydroxypropylmethyl-cellulose, sodium carboxymethylcellulose, and/or polyvinylpyrrolidone (PVP). If desired, disintegrating agents may be added, such as the cross-linked polyvinyl pyrrolidone, agar, or alginic acid or a salt thereof such as sodium alginate. Dragee cores are provided with suitable coatings. For this purpose, concentrated sugar solutions may be used, which may optionally contain gum arabic, talc, polyvinyl pyrrolidone, carbopol gel, polyethylene glycol, and/or titanium dioxide, lacquer solutions, and suitable organic solvents or solvent mixtures. Dyestuffs or pigments may be added to the tablets or dragee coatings for identification or to characterize different combinations of active ingredient doses. For this purpose, concentrated sugar solutions may be used, which may optionally contain gum arabic, talc, polyvinyl pyrrolidone, carbopol gel, polyethylene glycol, and/or titanium dioxide, lacquer solutions, and suitable organic solvents or solvent mixtures. Dyestuffs or pigments may be added to the tablets or dragee coatings for identification or to characterize different combinations of active ingredient doses. Such formulations can be made using methods known in the art. See, for example, U.S. Pat. Nos. 5,733,888 (injectable compositions); 5,726,181 (poorly water soluble compounds); 5,707,641 (therapeutically active proteins or peptides); 5,667,809 (lipophilic agents); 5,576,012 (solubilizing polymeric agents); 5,707,615 (anti-viral formulations); 5,683,676 (particulate medicaments); 5,654,286 (topical formulations); 5,688,529 (oral suspensions); 5,445,829 (extended release formulations); 5,653,987 (liquid formulations); 5,641,515 (controlled release formulations) and 5,601,845 (spheroid formulations); all of which are incorporated herein by reference in their entireties. The pharmaceutical compositions may be manufactured in a manner that is itself known, for example, by means of conventional mixing, dissolving, granulating, dragee-making, levitating, emulsifying, encapsulating, entrapping, or lyophilizing processes.

To formulate the dosage including one or more active ingredients disclosed herein, known surface active agents, excipients, smoothing agents, suspension agents and pharmaceutically acceptable film-forming substances and coating assistants, and the like may be used. Preferably alcohols, esters, sulfated aliphatic alcohols, and the like may be used as surface active agents; sucrose, glucose, lactose, starch, crystallized cellulose, mannitol, light anhydrous silicate, magnesium aluminate, magnesium methasilicate aluminate, synthetic aluminum silicate, calcium carbonate, sodium acid carbonate, calcium hydrogen phosphate, calcium carboxymethyl cellulose, and the like may be used as excipients; magnesium stearate, talc, hardened oil and the like may be used as smoothing agents; coconut oil, olive oil, sesame oil, peanut oil, soya may be used as suspension agents or lubricants; cellulose acetate phthalate as a derivative of a carbohydrate such as cellulose or sugar, or methylacetate-methacrylate copolymer as a derivative of polyvinyl may be used as suspension agents; and plasticizers such as ester phthalates and the like may be used as suspension agents. In addition to the foregoing ingredients, sweeteners, fragrances, colorants, preservatives and the like may be added to the administered formulation of the compound of the invention, particularly when the compound is to be administered orally.

Further disclosed herein are various pharmaceutical compositions well known in the pharmaceutical art for uses that include intraocular, intranasal, and intraauricular delivery. Pharmaceutical formulations include aqueous ophthalmic solutions of the active ingredients in water-soluble form, such as eyedrops, or in gellan gum (Shedden et al., Clin. Ther., 23(3):440-50 (2001)) or hydrogels (Mayer et al., Opthalmologica, 210(2):101-3 (1996)); ophthalmic ointments; ophthalmic suspensions, such as microparticulates, drug-containing small polymeric particles that are suspended in a liquid carrier medium (Joshi, A., J. Ocul. Pharmacol., 10(1):29-45 (1994)), lipid-soluble formulations (Alm et al., Prog. Clin. Biol. Res., 312:447-58 (1989)), and microspheres (Mordenti, Toxicol. Sci., 52(1):101-6 (1999)); and ocular inserts. All of the above-mentioned references are incorporated herein by reference in their entireties. Such suitable pharmaceutical formulations are most often and preferably formulated to be sterile, isotonic and buffered for stability and comfort. Pharmaceutical compositions may also include drops and sprays often prepared to simulate in many respects nasal secretions to ensure maintenance of normal ciliary action. As disclosed in Remington's Pharmaceutical Sciences, 18th Ed., Mack Publishing Co., Easton, Pa. (1990), which is incorporated herein by reference in its entirety, and well-known to those skilled in the art, suitable formulations are most often and preferably isotonic, slightly buffered to maintain a pH of 5.5 to 6.5, and most often and preferably include antimicrobial preservatives and appropriate drug stabilizers. Pharmaceutical formulations for intraauricular delivery include suspensions and ointments for topical application in the ear. Common solvents for such aural formulations include glycerin and water.

The compositions described herein may be administered by either oral or non-oral pathways. When administered orally, compositions can be administered in capsule, tablet, granule, spray, syrup, or other such form. Compositions also may be brewed, as with a tea, or formed by dissolving a powdered composition into a fluid, typically water, fruit or vegetable juice, or milk. When administered non-orally, it can be administered as an aqueous suspension, an oily preparation or the like or as a drip, suppository, salve, ointment or the like, when administered via injection, subcutaneously, intreperitoneally, intravenously, intramuscularly, or the like. Similarly, it may be administered topically, rectally, or vaginally, as deemed appropriate by those of skill in the art for bringing the ingredients of the invention into optimal contact with living tissue.

Agents intended to be administered intracellularly may be administered using techniques well known to those of ordinary skill in the art. For example, such agents may be encapsulated into liposomes, then administered by any of the methods described herein. All molecules present in an aqueous solution at the time of liposome formation are incorporated into the aqueous interior. The liposomal contents are both protected from the external micro-environment and, because liposomes fuse with cell membranes, are efficiently delivered into the cell cytoplasm. Additionally, due to their hydrophobicity, small organic molecules may be directly administered intracellularly.

In some embodiments, the compositions described herein are formulated into a single pill or tablet. In some embodiments, the pill or tablet has a mass from 10 mg to 2000 mg. In some embodiments, the pill or tablet has a mass from 100 mg to 1500 mg. In some embodiments, the pill or tablet has a mass from 500 mg to 1200 mg. In some embodiments, the pill or tablet has a mass from 800 mg to 1100 mg.

### Methods of Administration

Some embodiments also encompass methods for making and for administering the disclosed compositions. Such disclosed methods include, among others, (a) administration through oral pathways, which administration includes administration in capsule, tablet, granule, spray, syrup, or other such forms; (b) administration through non-oral pathways, which administration includes administration as an aqueous suspension, an oily preparation or the like or as a drip, suppository, salve, ointment or the like; administration via injection, subcutaneously, intraperitoneally, intravenously, intramuscularly, intradermally, or the like; as well as (c) administration topically, (d) administration rectally, or (e) administration vaginally, as deemed appropriate by those of skill in the art for bringing the compound of the invention into contact with living tissue; and (f) administration via controlled released formulations, depot formulations, and infusion pump delivery. As further examples of such modes of administration and as further disclosure of modes of administration, disclosed herein are various methods for administration of the disclosed compositions including modes of administration through intraocular, intranasal, and intraauricular pathways.

The pharmaceutically effective amount of the ingredients disclosed herein required as a dose will depend on the route of administration and the physical characteristics of the specific human under consideration. The dose can be tailored to achieve a desired effect, but will depend on such factors as weight, diet, concurrent medication and other factors, which those skilled in the medical arts will recognize.

In practicing the methods of the invention, the products or compositions can be used alone or in combination with one another or in combination with other therapeutic or diagnostic agents. These products can be utilized in vivo, ordinarily in a mammal, preferably in a human, or in vitro. In employing them in vivo, the products or compositions can be administered to the mammal in a variety of ways, including parenterally, intravenously, subcutaneously, intramuscularly, colonically, rectally, vaginally, nasally or intraperitoneally, employing a variety of dosage forms. Such methods may also be applied to testing chemical activity in vivo.

As will be readily apparent to one skilled in the art, the useful in vivo dosage to be administered and the particular mode of administration will vary depending upon the age, weight and mammalian species treated, the particular ingredients employed, and the specific use for which these ingredients are employed. The determination of effective dosage levels, that is the dosage levels necessary to achieve the desired result, can be accomplished by one skilled in the art using routine pharmacological methods. Typically, human clinical applications of products are commenced at lower dosage levels, with dosage level being increased until the desired effect is achieved. Alternatively, acceptable in vitro studies can be used to establish useful doses and routes of administration of the compositions identified by the present methods using established pharmacological methods. In non-human animal studies, applications of potential products are commenced at higher dosage levels, with dosage being decreased until the desired effect is no longer achieved or adverse side effects disappear.

The dosage of active ingredient(s) may range broadly, depending upon the desired affects and the therapeutic indication. Typically, dosages of active ingredient(s) may be between about 10 microgram/kg and 100 mg/kg body weight, preferably between about 100 microgram/kg and 10 mg/kg body weight. Alternatively dosages may be based and calculated upon the surface area of the patient, as understood by those of skill in the art. Administration is preferably oral on a daily or twice daily basis.

The exact formulation, route of administration and dosage can be chosen in view of the consumer's condition. See for example, Fingl et al., in The Pharmacological Basis of Therapeutics, 1975, which is incorporated herein by reference in its entirety. The magnitude of an administrated dose may vary with the severity of a particular medical or physical condition and the route of administration. The severity of a condition may, for example, be evaluated, in part, by standard prognostic evaluation methods. Further, the dose and perhaps dose frequency may also vary according to the age, body weight, and response of the individual. A program comparable to that discussed above may be used in veterinary medicine.

A variety of techniques for formulation and administration may be found in Remington's Pharmaceutical Sciences, 18th Ed., Mack Publishing Co., Easton, Pa. (1990), which is incorporated herein by reference in its entirety. Suitable administration routes may include oral, rectal, transdermal, vaginal, transmucosal, or intestinal administration; parenteral delivery, including intramuscular, subcutaneous, intramedullary injections, as well as intrathecal, direct intraventricular, intravenous, intraperitoneal, intranasal, or intraocular injections.

The combined active ingredients in the compositions disclosed herein may be orally or non-orally administered to a human patient in the amount of about 0.0007 mg/day to about 7,000 mg/day of the total active ingredients, and more preferably about 0.07 mg/day to about 70 mg/day of the total active ingredients at, one time per day or in other embodiments, over two to about ten times per day. Alternatively, the active ingredients disclosed herein may be administered in the stated amounts continuously by, for example, an intravenous drip. Thus, for a patient weighing 70 kilograms, the preferred daily dose of the total active ingredients would be about 0.0007 mg/kg/day to about 35 mg/kg/day, and more preferable, 0.007 mg/kg/day to about 15 mg/kg/day. Nonetheless, as will be understood by those of skill in the art, in certain situations it may be necessary to administer the active ingredients disclosed herein in amounts that excess, or even far exceed, the above-stated, preferred dosage range to treat effectively and aggressively a desired condition or characteristic.

Ingredients disclosed herein can be evaluated for efficacy and toxicity using known methods. For example, the toxicology of a particular compound or ingredient, or of a subset of the compounds, sharing certain chemical moieties, may be established by determining in vitro toxicity towards a cell line, such as a mammalian, and preferably a human, cell line. The results of such studies are often predictive of toxicity in animals, such as mammals, or more specifically, humans. Alternatively, the toxicity of particular compounds or ingredients in an animal model, such as mice, rats, rabbits, or monkeys, may be determined using known methods. The efficacy of a particular compound may be established using several recognized methods, such as in vitro methods, animal models, or human clinical trials. Recognized in vitro models exist for nearly every class of condition, including the conditions abated by the compounds or ingredients disclosed herein, including obesity. Similarly, acceptable animal models may be used to establish efficacy of chemicals to treat such conditions. When selecting a model to determine efficacy, the skilled artisan can be guided by the state of the art to choose an appropriate model, dose, and route of administration, and regime. Of course, human clinical trials can also be used to determine the efficacy of a compound or ingredient in humans.

The active ingredients described above may be used alone or in combination with one another, or in combination with other therapeutic or diagnostic agents. These products can be utilized in vivo or in vitro. The useful dosages and the most useful modes of administration will vary depending upon the age and weight of the consumer, the particular ingredients employed, and the specific use for which these ingredients are employed.

### Methods of Use

The compositions described herein may be used for promoting cellular hydration before, during and after practicing physical activity, such as flexibility exercises, aerobic exercises and/or anaerobic exercises. Such cellular hydration may also promote weight loss, increase energy, increase metabolic rate, increase thermogenesis, and/or decrease food cravings. Thus, in some embodiments, the compositions described herein are administered to a human diagnosed with obesity. In some embodiments, the compositions described herein are administered to a human considered overweight. In some embodiments, weight loss is achieved by a program that includes ingesting the compositions described herein, engaging in a regular exercise program, and having a healthy diet.

The following non-limiting examples are meant to describe the preferred methods of the invention using certain preferred embodiments of the invention. Variations in the details of the particular methods employed and in the precise compositions obtained will undoubtedly be appreciated by those of skill in the art.

### EXAMPLES

### Example 1

A tablet or mixture for preparation of a beverage is formulated having the ingredients and relative amounts listed in Table 1. In a tablet formulation the tablet is coated with a suitable coating material.

TABLE 1

| Ingredient | Amount (% of total tablet weight) |
|---|---|
| Dextrose | 47.8% |
| Fructose | 23.3% |
| Trehalose | 9.3% |
| Sucralose Powder | 0.2% |
| Tocopherol | 3.7% |
| Vitamin C | 0.5% |
| Beta Carotene | 0.2% |
| Citric Acid | 7.3% |
| Folic Acid | 0.1% |
| Calcium Lactate | 1.0% |
| Potassium Chloride | 0.8% |
| Potassium Citrate | 0.7% |
| Magnesium Oxide | 0.3% |
| Sodium Citrate | 1.0% |
| Sodium Chloride | 1.1% |
| N&A Lemonade | 2.7% |

### Example 2

A tablet or mixture for preparation of a beverage is formulated having the ingredients and relative amounts listed in Table 2. In a tablet formulation the tablet is coated with a suitable coating material.

TABLE 2

| Ingredient | Amount (% of total tablet weight) |
|---|---|
| Dextrose | 47.6% |
| Fructose | 23.3% |
| Trehalose | 9.3% |
| Sucralose Powder | 0.2% |
| Tocopherol | 3.7% |
| Citric Acid | 7.3% |
| Beta Carotene | 0.4% |
| Vitamin C | 0.5% |
| Folic Acid | 0.1% |
| Calcium Lactate | 1.0% |
| Potassium Chloride | 0.8% |
| Potassium Citrate | 0.7% |
| Magnesium Oxide | 0.3% |
| Sodium Citrate | 1.0% |
| Sodium Chloride | 1.1% |
| Orange | 2.7% |

### Example 3

A tablet or mixture for preparation of a beverage is formulated having the ingredients and relative amounts listed in Table 3. In a tablet formulation the tablet is coated with a suitable coating material.

TABLE 3

| Ingredient | Amount (% of total tablet weight) |
|---|---|
| Dextrose | 47.9% |
| Fructose | 23.3% |
| Trehalose Dihydrate | 9.3% |
| Sucralose Powder | 0.2% |
| Tocopherol | 3.7% |
| Citric Acid, Anhydrous | 7.3% |
| Calcium Lactate Pentahydrate | 1.0% |
| Sodium Citrate | 1.0% |
| Potassium Chloride | 0.8% |
| Potassium Citrate | 0.7% |
| Ascorbic Acid (Vitamin C) | 0.5% |
| Magnesium Oxide | 0.3% |
| Beta Carotene | 0.1% |
| Folic Acid | 0.1% |
| Sodium Chloride | 1.1% |
| Flavor (Lemonade) | 2.7% |

### Example 4

A tablet or mixture for preparation of a beverage is formulated having the ingredients and relative amounts listed in Table 4. In a tablet formulation the tablet is coated with a suitable coating material.

TABLE 4

| Ingredient | Amount (% of total tablet weight) |
|---|---|
| Dextrose | 47.8% |
| Fructose Powder | 23.3% |
| Trehalose Dihydrate | 9.3% |
| Sucralose Powder | 0.2% |
| Tocopherols | 3.7% |
| Citric Acid, Anhydrous | 7.3% |
| Calcium Lactate Pentahydrate | 1.0% |
| Sodium Citrate | 1.0% |
| Potassium Chloride | 0.8% |
| Potassium Citrate | 0.7% |
| Ascorbic Acid | 0.5% |
| Magnesium Oxide Powder | 0.3% |
| Beta Carotene | 0.2% |
| Folic Acid | 0.1% |
| Sodium Chloride | 1.1% |
| Flavor | 2.7% |

### Example 5

A tablet or mixture for preparation of a beverage is formulated having the ingredients and relative amounts listed in Table 5. In a tablet formulation the tablet is coated with a suitable coating material.

TABLE 5

| Ingredient | Amount (% of total tablet weight) |
|---|---|
| Maltodextrin | 15.8% |
| Fructose | 4.4% |
| Trehalose | 0.0% |
| Sorbitol | 21.6% |
| Sucralose Powder | 1.3% |
| Citric Acid | 27.5% |
| Beta Carotene | 1.1% |
| Vitamin C | 1.5% |
| Calcium Folinate | 0.3% |
| Calcium Lactate | 3.3% |
| Potassium Bicarbonate | 7.0% |
| Sodium Bicarbonate | 10.0% |
| Magnesium Oxide | 1.0% |
| PEG 800 | 0.3% |
| Canola Oil | 0.5% |
| Flavoring (orange) | 4.4% |

### Example 6

A tablet or mixture for preparation of a beverage is formulated having the ingredients and relative amounts listed in Table 6. In a tablet formulation the tablet is coated with a suitable coating material.

TABLE 6

| Ingredient | Amount (% of total tablet weight) |
|---|---|
| Maltodextrin | 15.0% |
| Fructose | 4.2% |
| Trehalose Dihydrate | 0.0% |
| Sorbitol | 20.5% |
| Sucralose Powder | 1.2% |
| Citric Acid | 26.0% |
| Beta Carotene | 0.0% |
| Vitamin C | 1.5% |
| Calcium Folinate | 0.3% |
| Calcium Lactate | 3.2% |
| Potassium Bicarbonate | 6.7% |
| Sodium Bicarbonate | 9.5% |
| Magnesium Oxide | 0.9% |
| PEG 800 | 0.2% |
| Canola Oil | 0.5% |
| Citrus blend | 10.4% |

### Example 7

A tablet or mixture for preparation of a beverage is formulated having the ingredients and relative amounts listed in Table 7. In a tablet formulation the tablet is coated with a suitable coating material.

TABLE 7

| Ingredient | Amount (% of total tablet weight) |
|---|---|
| Dextrose/Maltodextrin | 30.2% |
| Fructose Powder | 10.1% |
| Sucrose | 6.0% |
| Whey Protein Concentrate | 10.1% |
| Calcium Caseinate | 16.1% |
| Branched Chain Amino Acid | 5.0% |
| Non-Dairy Creamer | 10.1% |
| Creatine Monohydrate | 5.0% |
| Flavor | 3.0% |
| Xanthan gum | 0.2% |
| Guar Gum | 0.3% |
| Potassium Phosphate, Dibasic | 1.3% |
| Medium Chain Triglyceride | 0.5% |
| Food Colors | 0.1% |
| Vitamin Mineral Blend | 2.0% |

### Example 8

A tablet or mixture for preparation of a beverage is formulated having the ingredients and relative amounts listed in Table 8. In a tablet formulation the tablet is coated with a suitable coating material.

TABLE 8

| Ingredient | Amount (% of total tablet weight) |
|---|---|
| Sugar | 40.0% |
| Trehalose Dihydrate | 40.2% |
| Sucralose Powder | 0.2% |
| Tocopherol | 3.7% |
| Citric Acid | 7.3% |
| Beta Carotene | 0.4% |
| Vitamin C | 0.5% |
| Folic Acid | 0.1% |
| Calcium Lactate Pentahydrate | 1.0% |
| Potassium Chloride | 0.8% |
| Potassium Citrate | 0.7% |
| Magnesium Oxide | 0.3% |
| Sodium Citrate | 1.0% |
| Sodium Chloride | 1.1% |
| Flavor | 2.7% |

### Example 9

A tablet or mixture for preparation of a beverage is formulated having the ingredients and relative amounts listed in Table 9. In a tablet formulation the tablet is coated with a suitable coating material.

TABLE 9

| Ingredient | Amount (% of total tablet weight) |
|---|---|
| Sugar | 40.0% |
| Trehalose Dihydrate | 40.3% |
| Sucralose Powder | 0.2% |
| Tocopherol | 3.7% |
| Citric Acid | 7.3% |
| Beta Carotene | 0.4% |
| Vitamin C | 0.5% |
| Calcium Lactate Pentahydrate | 1.0% |
| Potassium Chloride | 0.8% |
| Potassium Citrate | 0.7% |
| Magnesium Oxide | 0.3% |
| Sodium Citrate | 1.0% |
| Sodium Chloride | 1.1% |
| Flavor | 2.7% |

### Example 10

A tablet or mixture for preparation of a beverage is formulated having the ingredients and relative amounts listed in Table 10. In a tablet formulation the tablet is coated with a suitable coating material.

TABLE 10

| Ingredient | Amount (% of total tablet weight) |
|---|---|
| Sugar | 40.0% |
| Trehalose Dihydrate | 40.6% |
| Sucralose Powder | 0.2% |
| Tocopherol | 3.7% |
| Citric Acid | 7.3% |
| Beta Carotene | 0.1% |
| Vitamin C | 0.5% |
| Calcium Lactate Pentahydrate | 1.0% |
| Potassium Chloride | 0.8% |
| Potassium Citrate | 0.7% |
| Magnesium Oxide | 0.3% |
| Sodium Citrate | 1.0% |
| Sodium Chloride | 1.1% |
| Flavor | 2.7% |

### Example 11

### Rapid Rehydration

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a measurement of body composition in terms of water content by an impedance meter test (a non-invasive analysis to measure body composition in terms of fats, water and lean mass) and/or through clinical or diagnostic procedures known in the art. The results from post-supplementation measurements can be compared with the pre-supplementation measurements and it will be found that by providing a sports rehydration supplement as described herein (e.g., see Examples 9 and 10) a subject's body water content can be maintained or improved. That is, in some embodiments, it is contemplated that body water content during and following exercise can be maintained or improved by consumption of the sports rehydration supplement, as described herein.

### Example 12

### Cramping and Intestinal Problems

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a survey, questionnaire, interview or clinical or diagnostic techniques known in the art. The results from the post-supplementation measurements can be compared with the pre-supplementation measurements and it will be found that by providing a sports rehydration supplement as described herein (e.g., see Examples 9 and 10) a subject does not incur cramping and intestinal problems. That is, in some embodiments, it is contemplated that the sports rehydration supplement with a osmolality of 190 to 300 mOsm/liter as described herein (e.g., see Examples 9 and 10) can provide rapid rehydration during and following exercise without causing cramping and intestinal problems common to those who drink competitive sports beverages.

### Example 13

### Antioxidant Effect

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a measurement of free radical activity in the body through a urine test to measure body lipid peroxide levels and/or through other clinical or diagnostic procedures known in the art. The results from the post-supplementation measurements can be compared with the pre-supplementation measurements and it will be found that by providing a sports rehydration supplement as described herein (e.g., see Examples 9 and 10) a subject's antioxidant levels can be strengthened. That is, in some embodiments, it is contemplated that body antioxidant levels can be maintained or improved by consumption of the sports rehydration supplement, as described herein.

### Example 14

### Providing Immediate and Sustained Energy

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a measurement of glucose concentration through a blood test and/or through clinical or diagnostic procedures known in the art. The results from the post-supplementation measurements can be compared with the pre-supplementation measurements and it will be found that by providing a sports rehydration supplement as described herein (e.g., see Examples 9 and 10) a subject's blood glucose level can be maintained over a prolonged period of time during exercise. That is, in some embodiments, it is contemplated that blood glucose levels during and following exercise can be maintained over an extended timeframe, and thus provide an immediate and sustained source of energy, by consumption of the sports rehydration supplement, as described herein.

### Example 15

### Blood Insulin Values

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a measurement of blood insulin values through a blood test and/or through clinical or diagnostic procedures known in the art. The results from the post-supplementation measurements can be compared with the pre-supplementation measurements and it may be found that consumption of a sports drink supplement as described herein (e.g., see Examples 9 and 10) does not give rise to excessive insulin spike that can have adverse effects on metabolism and/or athletic performance. That is, in some embodiments, it is contemplated that blood insulin values of the subject may be maintained during exercise without incurring an excessive insulin spike over an extended timeframe by consumption of the sports rehydration supplement, as described herein.

### Example 16

### Refreshing Taste

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a survey, questionnaire, interview or clinical or diagnostic techniques known in the art. The result from the post-supplementation measurements can be compared with the pre-supplementation measurements and it will be found that the sports rehydration supplement as described herein (e.g., see Examples 9 and 10) tastes better and more refreshing than water.

### Example 17

### Improved Energy and Stamina

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a measurement of performance parameters, including endurance capacity during exercise as well as muscle recovery and muscle damage, through measuring exercise duration time and a blood test (for assessing plasma CPK (creatinine phosphokinase) level) and/or through clinical or diagnostic procedures known in the art. The results from the post-supplementation measurements can be compared with the pre-supplementation measurements and it will be found that administration of a sports rehydration supplement as described herein (e.g., see Examples 9 and 10) gives rise to better tolerance of physical efforts, faster muscle recovery and less extent of muscle damage. That is, in some embodiments, it is contemplated that the subject can endure longer time of exercise before exhaustion and achieve a greater workload by consumption of the sports rehydration supplement, as described herein, compared to drinking water or no beverage.

### Example 18

### Soreness and Discomfort

The study involves a subject who practices physical activity, such as flexibility exercises, aerobic exercises and/or anaerobic exercises. Before, during or after exercise, the subject is provided with a sports rehydration supplement, as described herein (e.g., see Examples 9 and 10). In some embodiments, the sports rehydration supplement is provided at least once, twice or three times a day for a set period, which can be at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive days or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive weeks or at least, less than, greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 consecutive months. At various time points during the supplementation period, an analysis of the subject can be performed. Such analysis may include a survey, questionnaire, interview or clinical or diagnostic techniques known in the art. It will be found that by providing a sports rehydration supplement as described herein (e.g., see Examples 9 and 10) it is less likely for a subject to develop soreness and discomfort in active muscle and joints during and after exercise. That is, in some embodiments, it is contemplated that the sports rehydration supplement which has a higher ORAC value and can produce greater plasma antioxidant than regular sports formula, as described herein (e.g., see Examples 9 and 10), can prevent the development of soreness and discomfort in muscle and joints that have been stressed by exercise. In some embodiments, it is contemplated that this effect is especially noted in untrained and lapsed athletes who return to aggressive exercise and experience the resulting soreness and muscle strain.

It will be appreciated by those skilled in the art that various modifications and changes may be made without departing from the scope of the invention. Such modifications and changes are intended to fall within the scope of the invention, as defined by the appended claims.

What is claimed is:

1. A mixture for preparation of a beverage, the beverage having (1) a weight:weight ratio of sodium to potassium from approximately 0.6:1 to approximately 1.3:1 and (2) an osmolality 150-350 mOsm/liter.

2. The mixture of claim 1, wherein the weight:weight ratio of sodium to potassium is from approximately 0.95:1 to approximately 1.05:1.

3. The mixture of claim 1, wherein the weight:weight ratio of sodium to potassium is approximately 0.85:1.

4. The mixture of claim 1, wherein the weight:weight ratio of sodium to potassium is approximately 1:1.

5. The mixture of claim 1, wherein the osmolality of the beverage is between approximately 180 to approximately 330 mOsm/liter.

6. The mixture of claim 1, wherein the osmolality of the beverage is approximately 230 mOsm/liter.

7. The mixture of claim 1 comprising trehalose and sucralose.

8. The mixture of claim 7, wherein the weight:weight ratio of trehalose to sucralose is between approximately 200:1 and approximately 205:1.

9. The mixture of claim 7 further comprising tocopherols and vitamin C.

10. The mixture of claim 9, wherein the tocopherol is present in an amount sufficient to produce anti-inflammatory benefits in humans.

11. The mixture of claim 1 comprising sugar, trehalose dihydrate, sucralose, tocopherol, citric acid, beta carotene, ascorbic acid, calcium lactate pentahydrate, potassium chloride, potassium citrate, magnesium oxide, sodium citrate and sodium chloride.

12. The mixture of claim 11, comprising 20-40% by weight sugar, 20-60% by weight trehalose dihydrate, 0.01-2% by weight sucralose, 1-10% by weight tocopherol, 4-20% by weight citric acid, 0.01-2% by weight beta carotene, 0.1-5% by weight ascorbic acid, 0.1-5% by weight calcium lactate pentahydrate, 0.1-5% by weight potassium chloride, 0.1-5% by weight potassium citrate, 0.1-2% by weight magnesium oxide, 0.1-5% by weight sodium citrate and 0.1-5% by weight sodium chloride.

13. The mixture of claim 1 comprising Dextrose, Fructose, Trehalose, Sucralose, Tocopherol, Vitamin C, Beta Carotene, Citric Acid, Folic Acid, Calcium Lactate, Potassium Chloride, Potassium Citrate, Magnesium Oxide, Sodium Citrate and Sodium Chloride.

14. The mixture of claim 13 comprising 47.8% by weight Dextrose, 23.3% by weight Fructose, 9.3% by weight Trehalose, 0.2% by weight Sucralose, 3.7% by weight Tocopherol, 0.5% by weight Vitamin C, 0.2% by weight Beta Carotene, 7.3% by weight Citric Acid, 0.1% by weight Folic Acid, 1.0% by weight Calcium Lactate, 0.8% by weight Potassium Chloride, 0.7% by weight Potassium Citrate, 0.3% by weight Magnesium Oxide, 1.0% by weight Sodium Citrate and 1.1% by weight Sodium Chloride.

15. The mixture of claim 1 comprising Dextrose, Fructose, Trehalose, Sucralose, Tocopherol, Citric Acid, Beta Carotene, Vitamin C, Folic Acid, Calcium Lactate, Potassium Chloride, Potassium Citrate, Magnesium Oxide, Sodium Citrate and Sodium Chloride.

16. The mixture of claim 15 comprising 47.6% by weight Dextrose, 23.3% by weight Fructose, 9.3% by weight Trehalose, 0.2% by weight Sucralose, 3.7% by weight Tocopherol, 7.3% by weight Citric Acid, 0.4% by weight Beta Carotene, 0.5% by weight Vitamin C, 0.1% by weight Folic Acid, 1.0% by weight Calcium Lactate, 0.8% by weight Potassium Chloride, 0.7% by weight Potassium Citrate, 0.3% by weight Magnesium Oxide, 1.0% by weight Sodium Citrate and 1.1% by weight Sodium Chloride.

17. The mixture of claim 11, wherein the sugar comprises glucose.

18. The mixture of claim 11, wherein the sugar comprises sucrose.

19. The mixture of claim 7 further comprising sucrose.

20. The mixture of claim 19, wherein a weight:weight ratio of trehalose to sucrose is between approximately 0.8:1.0 and approximately 1.3:1.0.
